(19) United States
(12) Patent Application Publication
(10) Pub. No.: US 2016/0053901 A1
(43) Pub. Date: Feb. 25, 2016

(54) PNEUMATIC VALVE FOR VEHICLE

(71) Applicants: Hyundai Dymos Incorporated, Chungcheongnam-do (KR); Inzicontrols Co., LTD., Gyeonggi-do (KR)

(72) Inventors: Dong Gi Kim, Gyeonggi-do (KR); In Ho Lee, Gyeonggi-do (KR); Sin Jeong Kang, Gyeonggi-do (KR); Sung Hoon Kim, Seoul (KR); Jong Dae Lim, Gyeonggi-do (KR); Taek Seung Kim, Seoul (KR); Kwang Bok Park, Gyeonggi-do (KR); Jeong Dae Kim, Incheon (KR)

(21) Appl. No.: 14/832,661

(22) Filed: Aug. 21, 2015

(30) Foreign Application Priority Data
Aug. 22, 2014 (KR) 10-2014-0109649

(51) Int. Cl. F16K 11/24; F16K 11/10; F16K 31/06; B60N 2/44

(52) U.S. Cl. CPC F16K 11/24; B60N 2/4415; F16K 11/105; F16K 31/0679

(57) ABSTRACT

Disclosed is a pneumatic valve for a vehicle that includes a valve housing that has an intake hole in an intake unit at one end, an exhaust hole and a relief hole in an exhaust unit at another end, and a channel through which air flows therein. An intake plunger selectively opens and closes the intake hole by sliding in the channel of the valve housing. A relief plunger selectively opens and closes the relief hole by sliding in the channel of the valve housing. An intake coil is disposed outside the valve housing and slides the intake plunger using an electromagnetic force; and a relief coil is disposed outside the valve housing and slides the relief plunger using an electromagnetic force.

### CROSS-REFERENCE TO RELATED APPLICATIONS

The present application claims the benefit of Korean Patent Application No. 10-2014-0109649, filed Aug. 22, 2014, which is hereby incorporated by reference in its entirety.

### FIELD

The present disclosure relates to a pneumatic valve for a vehicle that allows for reduction of size and weight of valves.

### BACKGROUND

The statements in this section merely provide background information related to the present disclosure and may not constitute prior art.

The present disclosure relates to a bidirectional integrated pneumatic solenoid valve for a vehicle.

In the prior art, 1) there is a problem with size and weight due to separate assembly of an intake/exhaust structure and addition of a connection structure when a unidirectional separate type actuator is applied, and 2) it is difficult to control air leakage and ensure pressure in an intake/exhaust connection structure that is an intake-intake actuator assembly/exhaust-exhaust actuator assembly structure when expanding a valve.

### SUMMARY

Accordingly, the present disclosure proposes a structure that can reduce the size and weight of valves by improving the structure of an actuator and can improve reliability in an easy connection method in comparison to those of the related prior art when expanding a system and an integrated structure that can adjust intake/exhaust of air with one actuator.

The present disclosure in one form is a structure that can adjust the intake/exhaust of air with one actuator by applying an integrated bidirectional structure to an actuator and can keep airflow uniformly by continuously connecting an intake port of air. Further, the present disclosure provides a device that allows for easy attachment and detachment of actuators by providing specific fixing portions at the upper and lower portions of the actuators other than an intake port at joints of valves and that can improve expansion efficiency and reliability by preventing rotation possibility between the valves after assembly, when expanding a system.

The present disclosure provides a pneumatic valve for a vehicle that allows for reduction of size and weight of the valves by improving the structure of an actuator, and makes it easy to couple a system and an integrated structure, which can adjust intake/exhaust of air with one actuator, and can improve reliability when expanding the integrated structure and the system.

According to an aspect of the present disclosure, there is provided a pneumatic valve for a vehicle including: a valve housing that has an intake hole in an intake unit at one end, an exhaust hole and a relief hole in an exhaust unit at another end, and a channel through which air flows therein; an intake plunger that opens/closes the intake hole by sliding in the channel of the valve housing; a relief plunger that opens/closes the relief hole by sliding in the channel of the valve housing; an intake coil that is disposed outside the valve housing and slides the intake plunger using an electromagnetic force; and a relief coil that is disposed outside the valve housing and slides the relief plunger using an electromagnetic force.

The intake hole and the relief hole may be opened/closed by the intake plunger and the relief plunger, and the exhaust hole may communicate with the channel of the valve housing, when being open.

The intake plunger and the relief plunger may be spaced from each other and an elastic member is disposed therebetween, so the plungers may close the intake hole and the relief hole by being pressed in opposite directions as a normal close type.

The intake plunger may be disposed closer to the intake hole than the intake coil, so when the intake coil is operated, the intake plunger may be moved back to the center of the valve housing and the intake hole may be opened.

The relief plunger may be disposed closer to the relief hole than the relief coil, so when the relief coil is operated, the relief plunger may be moved back to the center of the valve housing and the relief hole may be opened.

A core may be disposed at the center of the channel of the valve housing and the core may divide the channel into a first side and a second side, with the outer side in close contact with the inner side of the channel.

A passage may be formed through the center of the core, and the channels of the valve housing divided into the first side and the second side may communicate with each other through the passage.

The intake plunger and the relief plunger may slide, with the outer sides in contact with the inner side of the channel.

A channel groove recessed to the intake unit from an end at the center of the channel may be formed on the intake plunger and an end of the channel groove may communicate with the intake unit through a through-hole.

A channel groove recessed to the exhaust unit from an end at the center of the channel may be formed on the relief plunger and an end of the channel groove may communicate with the exhaust unit through a through-hole.

Shock-absorbing portions made of an elastic material may be disposed outside ends of the channels of the intake plunger and the relief plunger and may close the intake hole and the relief hole, respectively.

Seat portions made of an elastic material may be disposed at ends at the centers of the channels facing each other of the intake plunger and the relief plunger and an elastic member may be disposed between the seat portions, so the intake plunger and the relief plunger may be pressed in opposite directions.

The valve housing may be divided into a first part and a second part, and the first part and the second part may be combined and fixed by coupling a fixing housing to the outer sides of the first part and the second part being in contact with each other such that channels are connected.

An intake nipple and an exhaust nipple may be formed in the intake hole and the exhaust hole of the valve housing, respectively, and the intake nipple may be bent to a side to communicate with an intake nipple of another adjacent valve housing.

A pneumatic sensor may be disposed in the exhaust nipple of the valve housing.

With intake nipples of a plurality of valve housings connected to each other, the last intake nipple may be connected to a compressor, relief holes may communicate with atmosphere, and exhaust nipples may be connected to expansion objects, respectively.

A hook structure may be formed on a side of the valve housing, so the hook structure may be coupled to a hook structure on a side of another adjacent valve housing.

According to the pneumatic valve for a vehicle according to the present disclosure as described above, it has an intake-exhaust integrated (bidirectional) solenoid valve structure, so it is possible to reduce the numbers of parts/modules and processes, reduce the weight, and improve the size by reducing the number of parts and sharing the parts in comparison to intake-exhaust separate type (unidirectional) structures of the related art.

When any one of the intake plunger and the relief plunger operates, the pressing force of the elastic member increases so that the closing force at another side can be increased.

Further, connection efficiency may be improved by providing a hook structure to a side and upper/lower portions of a valve housing in order to expand a solenoid valve system into a multifunction type, and the hook structures of the intake unit and the relief unit are designed in opposite directions, so it is possible to improve expansion efficiency and reliability (against air leakage etc.) by preventing rotation of an actuator after valve expansion and assembly.

Further, as a pressure sensor insertion type valve structure according to the present disclosure, a pressure sensor can be inserted/attached to a valve housing and an upper end of a solenoid actuator, so a pneumatic adjustment controller and a solenoid actuator are integrated, and accordingly, pressure control can be performed without specific structural change.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a pneumatic valve for a vehicle according to one form of the present disclosure;

FIG. 2 is a cross-sectional view of the pneumatic valve for a vehicle according to one form of the present disclosure; and

FIG. 3 is a plan view of the pneumatic valve for a vehicle according to one form of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

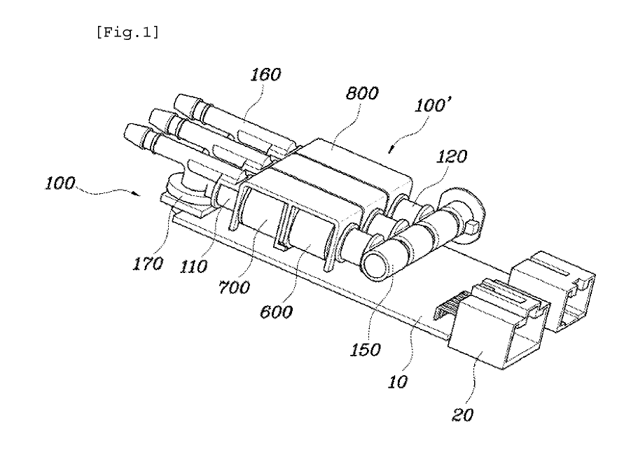

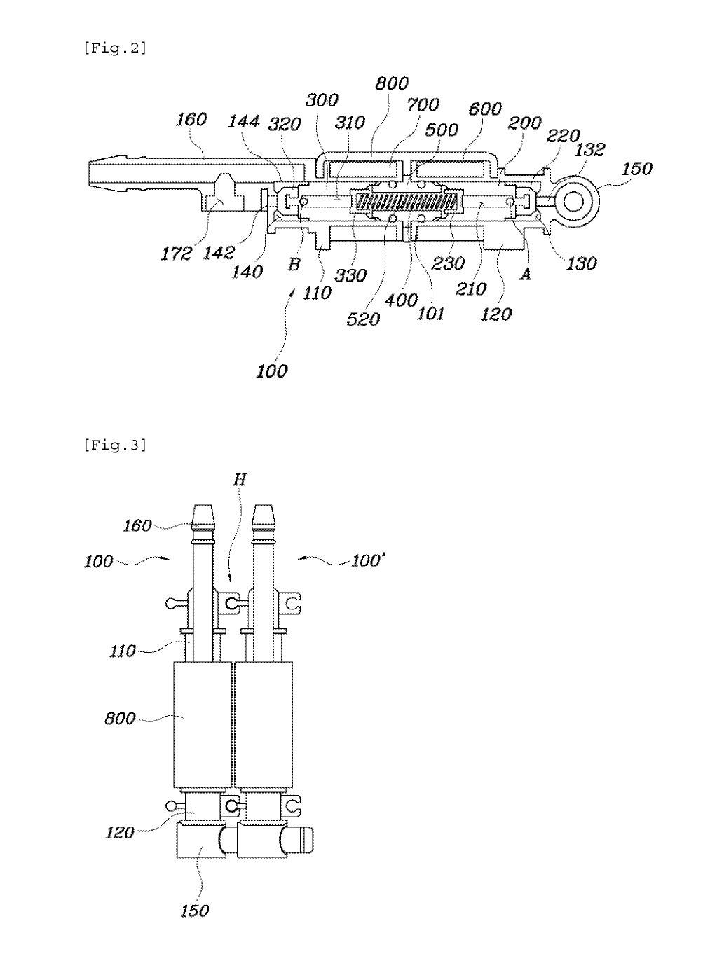

FIG. 1 is a perspective view of a pneumatic valve for a vehicle according to a form of the present disclosure, FIG. 2 is a cross-sectional view of the pneumatic valve for a vehicle according to one form of the present disclosure, and FIG. 3 is a plan view of the pneumatic valve for a vehicle according to one form of the present disclosure.

Adjustment devices that can support the waist/sides/buttocks of passengers using a pneumatic system are used in automotive seats. A valve of the present disclosure has a bidirectional integrated structure that can be easily expanded, and can be applied to a pneumatic adjustment system for a vehicle, as described below.

For example, there are a lumber support (waist support), a bolster adjustment device (side/thigh support), a cushion adjustment device (buttocks/thigh), and a massage system (whole body relax).

According to the present disclosure, channels and coupling parts that are required for a separate type actuator structure are removed by integrating an intake/exhaust actuator. In existing solenoid valves, an intake/exhaust are separate configurations, so a housing, a core, and a spring are specifically used for each of the intake/exhaust. In the present disclosure the main parts are simplified/shared, and accordingly, weight/size/manufacturing cost can be reduced.

When a voltage is applied, an intake operation is performed, in which an intake plunger moves toward a core so that an intake hole is opened and pneumatic pressure is supplied through an exhaust hole. Further, in a relief operation, a relief plunger moves toward the core so that a relief is opened.

The valve structure can be expanded by assembling/disassembling actuators by adding two protrusions and connecting portions on sides, other than air intake unit assembly structures at lower ends of the actuators. Actuators are fixed through connection structures on the sides, and the upper/lower portions of the actuators, so when a valve housing is assembled or adjustment for intake/exhaust is performed, the actuators may be fixed in a predetermined direction without rotation, so reliability against air leakage can be improved.

Further, in some cases, the flow rate controls are not simple, and flow rate is controlled by a precise pressure control in accordance with characteristics of a system, when a pneumatic valve is applied to a seat. The present disclosure allows for pressure control without a specific valve change by allowing for insertion/attachment of a pressure sensor at the upper ends of a valve housing and a solenoid actuator.

In detail, a pneumatic valve for a vehicle according to the present disclosure includes: a valve housing 100 that has an intake hole 132 in an intake unit 130 at one end, an exhaust hole 144 and a relief hole 142 in an exhaust unit 140 at another end, and a channel through which air flows therein; an intake plunger 200 that selectively opens/closes the intake hole 132 by sliding in the channel of the valve housing 100; a relief plunger 300 that selectively opens/closes the relief hole 142 by sliding in the channel of the valve housing 100; an intake coil 600 that is disposed outside the valve housing 100 and slides the intake plunger 200 using an electromagnetic force; and a relief coil 700 that is disposed outside the valve housing 100 and slides the relief plunger 300 using an electromagnetic force.

As shown in FIG. 2, the intake hole 132 is formed in the intake unit 130 at an end of the valve housing 100, the exhaust hole 144 and the relief hole 142 are both formed in the exhaust unit 140 at another end, and the channel through which air flows is formed therein.

The valve housing 100 is divided into a first part 110 and a second part 120, and the first part 110 and the second part 120 can be combined and fixed by coupling a fixing housing 800 to the outer sides of the first part 110 and the second part 120 being in contact with each other such that channels are connected.

The intake hole 132 and the exhaust hole 144 of the valve housing 100 are formed at both ends to face each other in a line, an intake nipple 150 and an exhaust nipple 160 are formed in the intake hole 132 and the exhaust hole 144, respectively, and the intake nipple 150 may be curved to a side to communicate with an intake nipple of another adjacent valve housing, as shown in FIG. 3. When the intake nipple 150 is formed in a T-shape by bending it to both sides, the end that is not coupled to another intake nipple may be closed by a cap.

Further, a pneumatic sensor 170 may be disposed through a mounting hole 172 in the exhaust nipple 160 of the valve housing 100. Accordingly, pressure to the exhaust side is measured so that intake can be actively controlled.

On the other hand, as in FIG. 3, with the intake nipples 150 of a plurality of valve housings 100 connected to each other, the last intake nipple 150 may be connected to a compressor, the relief holes 142 may communicate with atmosphere, and the exhaust nipples 160 may be connected to expansion objects, respectively. Accordingly, it is possible to individually control expansion objects such as a plurality of cushions with one compressor.

A hook structure H is formed on a side of the valve housing 100, so it can be coupled to the hook structure on a side of another adjacent valve housing. Accordingly, it is possible to construct a system through sharing regardless of the number of expansion objects.

The hook structure H may be formed at the intake side and the exhaust side and may be composed of a hook-shaped male portion and a groove-shaped female portion. As for the male portion, when the male portion of any one of the intake side and the exhaust side is bent upward in a ring shape, the male portion of the other one is bent downward in a ring shape, so rotation of the valve housings is inhibited, with the two hook structures being coupled.

Further, the intake plunger 200 selectively opens/closes the intake hole 132 by sliding in the channel in the valve housing 100 and the relief plunger 300 selectively opens/closes the relief hole 142 by sliding in the channel of the valve housing 100.

The intake hole 132 and the relief hole 142 are selectively opened/closed by the intake plunger 200 and the relief plunger 300 and the exhaust hole 144 may always communicate with the channel of the valve housing 100 when it is open.

In detail, as in FIG. 2, the intake plunger 200 and the relief plunger 300 are spaced from each other and an elastic member 400 is disposed there between, so it may be a normal close type in which the plungers close the intake hole 132 and the relief hole 142 by being pressed in opposite directions.

The intake plunger 200 is disposed closer to the intake hole 132 than the intake coil 600, so when the intake coil 600 is operated, the intake plunger 200 is moved back to the center of the valve housing 100 and the intake hole 132 may be opened. Further, the relief plunger 300 is disposed closer to the relief hole 142 than the relief coil 700, so when the relief coil 700 is operated, the relief plunger 300 is moved back to the center of the valve housing 100 and the relief hole 142 may be opened.

Further, a channel groove 210 recessed to the intake unit 130 from an end at the center of the channel is formed on the intake plunger 200 and an end of the channel groove 210 may communicate with the intake unit 130 through a through-hole A. Further, a channel groove 310 recessed to the exhaust unit 140 from an end at the center of the channel is formed on the relief plunger 300 and an end of the channel groove 310 may communicate with the exhaust unit 140 through a through-hole B.

Shock-absorbing portions 220 and 320 made of an elastic material are disposed outside ends of the intake plunger 200 and the relief plunger 300 and may close the intake hole 132 and the relief hole 142, respectively. Accordingly, noise and vibration due to operation are reduced.

In particular, seat portions 230 and 330 made of an elastic material are disposed at ends of the centers of the channels facing each other of the intake plunger 200 and the relief plunger 300 and an elastic member 400 is disposed between the seat portions 230 and 330, so the intake plunger 200 and the relief plunger 300 may be pressed in opposite directions. Accordingly, operational noise and vibration may be improved.

Further, by this structure, when any one of the intake plunger 200 and the relief plunger 300 operates, the pressing force of the elastic member 400 increases so that the closing force at another side may be increased.

The intake coil 600 is disposed outside the valve housing 100 to slide the intake plunger 200 using an electromagnetic force and the relief coil 700 is disposed outside the valve housing 100 to slide the relief plunger 300 using an electromagnetic force.

Further, a core 500 is disposed at the center of the channel of the valve housing 100 and can divide the channel into a first side and a second side with the outer surface in close contact with an inner side of the channel.

Further, a passage 520 is formed passing through the center of the core 500, so the channels of the valve housing 100 divided into the first side and the second side may communicate with each other through the passage.

The intake plunger 200 and the relief plunger 300 may slide, with the outer sides in contact with the inner side of the channel.

According to this configuration, when the intake plunger 200 is operated by the intake coil 600, the intake plunger 200 slightly slides to the left in FIG. 2. The intake plunger 200 slides left as much as the small space defined by the intake coil 600 and the core 500. Basically, the intake plunger 200 is completely sealed with the inner side of the valve housing 100. When the intake plunger 200 slides, pneumatic pressure is applied from the intake nipple 150 to the intake unit 130, and the pneumatic pressure is transmitted to the channel groove 210 of the intake plunger 200 through the through-hole A.

Further, the pneumatic pressure is transmitted to the relief plunger 300 through the channel groove 210 of the intake plunger 200 and the passage 520 of the core 500, transmitted to the exhaust unit 140 through the channel groove 310 of the relief plunger 300 and through the through-hole B, and then supplied to an expansion object through the exhaust hole 144. Accordingly, a desired intake plunger 200 is selectively controlled to expand a specific expansion object.

In order to reduce the pressure of a specific expansion object, the relief plunger 300 corresponding to the expansion object is operated. When the corresponding relief coil 700 is operated, the relief plunger 300 slightly slides to the right, in which the pneumatic pressure of the exhaust unit 140 is discharged outside through the relief hole 142. In this case, the intake plunger 200 closes the intake hole 132 and the pneumatic sensor 170 measures the pneumatic pressure of the exhaust unit 140 to indirectly measure the pressure of the expansion object and control relief.

FIG. 3 shows coupling of a plurality of valves, in which the valve housing 100 is divided into a first part 110 and a second part 120, and the first part 110 and the second part 120 may be combined and fixed by coupling a fixing housing 800 to the outer sides of the first part 110 and the second part 120 being in contact with each other such that channels are connected.

An intake nipple 150 and an exhaust nipple 160 are formed in the intake hole 132 and the exhaust hole 144 of the valve housing 100, respectively, and the intake nipple 150 may be bent to a side to communicate with the intake nipple of another adjacent valve housing.

With the intake nipples 150 of a plurality of valve housings 100 connected to each other, the last intake nipple 150 may be connected to a compressor, the relief holes 142 may communicate with atmosphere, and the exhaust nipples 160 may be connected to expansion objects, respectively.

A hook structure H is formed on a side of the valve housing 100, so it can be coupled to the hook structure on a side of another adjacent valve housing.

Referring to FIG. 1, the plurality of valves are completed by being fixed to one substrate 10 and connector 20.

According to the pneumatic valve for a vehicle according to the present disclosure as described above, it has an intake-exhaust integrated (bidirectional) solenoid valve structure, so it is possible to reduce the numbers of parts/modules and processes, reduce the weight, and improve the size by reducing the number of parts and sharing the parts in comparison to intake-exhaust separate type (unidirectional) structures of the related art.

Further, by applying an anti-noise device to an actuator operation part in order to reduce noise when an electromagnetic armature is attached/detached due to direct movement of a ferromagnetic substance, which is a problem in operation of a solenoid valve in the related prior art. The present disclosure in one form is capable of reducing noise when a valve is operated was achieved.

Further, assembly efficiency was improved by providing one protrusion and one connecting portion at a side and upper/lower portions of an actuator in order to expand a solenoid valve system into a multifunction type, and it is possible to improve expansion efficiency and reliability (against air leakage etc.) by preventing rotation of an actuator after valve expansion and assembly.

Further, as a pressure sensor insertion type valve structure according to the present disclosure, a pressure sensor may be inserted/attached to a valve housing and an upper end of a solenoid actuator, so a pneumatic adjustment controller and a solenoid actuator are integrated, and accordingly, pressure control may be performed without specific structural change.

Forms described may be changed or modified by those skilled in the art to which the present disclosure pertains without departing from the scope of the present disclosure, and various alterations and modifications are possible within the technical spirit of the present disclosure and the equivalent scope of the claims which will be described below.

What is claimed is:

1. A pneumatic valve for a vehicle, comprising:
a valve housing that has an intake hole in an intake unit at one end, an exhaust hole and a relief hole in an exhaust unit at another end, and a channel through which air flows therein;
an intake plunger that selectively opens and closes the intake hole by sliding in the channel of the valve housing;
a relief plunger that selectively opens and closes the relief hole by sliding in the channel of the valve housing;
an intake coil that is disposed outside the valve housing and slides the intake plunger using an electromagnetic force; and
a relief coil that is disposed outside the valve housing and slides the relief plunger using an electromagnetic force.

2. The pneumatic valve for a vehicle of claim 1, wherein the intake hole and the relief hole are selectively opened and closed by the intake plunger and the relief plunger, and the exhaust hole always communicates with the channel of the valve housing, when being open.

3. The pneumatic valve for a vehicle of claim 1, wherein the intake plunger and the relief plunger are spaced from each other and an elastic member is disposed there between, so the plungers close the intake hole and the relief hole by being pressed in opposite directions as a normal close type.

4. The pneumatic valve for a vehicle of claim 3, wherein when the intake coil is operated, the intake plunger is moved back to a center of the valve housing and the intake hole is opened.

5. The pneumatic valve for a vehicle of claim 3, wherein when the relief coil is operated, the relief plunger is moved back to a center of the valve housing and the relief hole is opened.

6. The pneumatic valve for a vehicle of claim 3, wherein a core is disposed at a center of the channel of the valve housing, the core divides the channel into a first side and a second side, with the outer side in close contact with the inner side of the channel, a passage is formed passing through a center of the core, and the channels of the valve housing divided into the first side and the second side communicate with each other through the passage of the core.

7. The pneumatic valve for a vehicle of claim 1, wherein the intake plunger and the relief plunger each slide with the outer sides in contact with the inner side of the channel.

8. The pneumatic valve for a vehicle of claim 1, wherein a channel groove recessed to the intake unit is formed on the intake plunger and an end of the channel groove communicates with the intake unit through a through-hole, and
a channel groove recessed to the exhaust unit is formed on the relief plunger and an end of the channel groove communicates with the exhaust unit through a through-hole.

9. The pneumatic valve for a vehicle of claim 1, wherein seat portions made of an elastic material are disposed at ends of each other of the intake plunger and the relief plunger and an elastic member is disposed between the seat portions, so the intake plunger and the relief plunger are pressed in opposite directions.

10. The pneumatic valve for a vehicle of claim 1, wherein the valve housing is divided into a first part and a second part, and the first part and the second part are combined and fixed by coupling a fixing housing to the outer sides of the first part and the second part being in contact with each other such that channels are connected.

11. The pneumatic valve for a vehicle of claim 1, wherein an intake nipple and an exhaust nipple are formed in the intake hole and the exhaust hole of the valve housing, respectively, and the intake nipple is bent to a side to communicate with an intake nipple of another adjacent valve housing.

12. The pneumatic valve for a vehicle of claim 11, wherein with intake nipples of a plurality of valve housings connected to each other, the last intake nipple is connected to a compressor, relief holes communicate with atmosphere, and exhaust nipples are connected to expansion objects, respectively.

13. The pneumatic valve for a vehicle of claim 1, wherein a hook structure is formed on a side of the valve housing, so the hook structure is coupled to a hook structure on a side of another adjacent valve housing.

14. The pneumatic valve for a vehicle of claim 13, wherein the hook structure is composed of a hook-shaped male portion and a groove-shaped female portion, the hook structure is disposed at an intake side and an exhaust side, and the male portion of the intake side and the male portion of the exhaust side are bent in opposite directions in a ring shape.
